(19) United States
(12) Patent Application Publication
(10) Pub. No.: US 2012/0076072 A1
(43) Pub. Date: Mar. 29, 2012

(54) SYSTEM AND METHOD FOR MAINTAINING PRIVACY IN A WIRELESS NETWORK

(76) Inventors: Marc JALFON, Zichron Yaakov (IL); Gideon Prat, Haifa (IL)

(21) Appl. No.: 12/889,806

(22) Filed: Sep. 24, 2010

(51) Int. Cl. H04W 4/00

(52) U.S. Cl. 370/328

(57) ABSTRACT

A system and method for of maintaining privacy in a wireless network is provided. A wireless communication device may transmit, to a broadcast address, a plurality of messages using a respective plurality of source identifiers. A response to at least one of the plurality of messages may be received. A predefined source identifier is used to establish a link. Other embodiments are described and claimed.

### BACKGROUND OF THE INVENTION

Computer networks may be built using either wired or wireless technology. Wired networking, e.g., Ethernet, has been the traditional choice for a number of decades. However, wired network cables are physically connected to each computer on a network. Accordingly, setting up or changing a setup of a wired network as well as other maintenance tasks related to wired networks may be time-consuming and costly.

Wireless networking has now become one of the most common and wide spread networking technologies. Many computing devices, e.g., digital personal assistance (PDA) devices, home computers, including peripheral devices thereof, laptop computers, tablet computers, mobile and/or wireless communication devices such as “smart phones”, etc., may all be capable of communicating over one or more wireless networks, e.g., IEEE 802.11, 802.15, 802.16, etc. Wireless technology may offer a number of advantages over its wired predecessor. The success and wide acceptance of wireless technology may be attributed to the fact that setting up a network using wireless technology is easier, typically cheaper, and faster compared to the same task when using wired technology. In addition, users or devices are no longer required to be tied to a specific location in order to communicate over the network.

However, various problems related to wireless networks remain unsolved. For example, data transmitted over a wireless network may not be secure. For example, such data may be susceptible to being intercepted by another, possibly hostile, wireless communication device.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows an exemplary wireless network system according to embodiments of the invention;

FIG. 2 shows an exemplary time event flow chart according to embodiments of the invention;

FIG. 3 shows an exemplary computing device according to embodiments of the invention; and

FIG. 4 is a flowchart diagram illustrating a method according to some embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding embodiments of the invention. However, it will be understood by those of ordinary skill in the art that embodiments of the invention may be practiced without these specific details. In other instances, well-known methods, procedures, components, modules, units and/or circuits have not been described in detail so as not to obscure embodiments of the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time.

Embodiments of the invention may enable a wireless communication device to operate in a wireless environment without disclosing or revealing information, data or parameters to other, e.g., hostile or other, wireless communication devices. As known in the art, a device communicating over a computer network may be associated with one or more identifiers or parameters. For example, a media access control (MAC) address may be associated with a wireless communication device. Although MAC address will mostly be referred to herein, it will be understood that similar identifiers or parameters may likewise be used. Typically, MAC addresses are assigned to network interfaces (that may be wired or wireless) and are used in order to identify a source and/or destination of a communication. MAC addresses are typically uniquely assigned to devices. The allocation of MAC addresses is managed by the Institute of Electrical and Electronics Engineers (IEEE). For example, in order to maintain uniqueness, MAC addresses are allocated to manufacturers of networking equipment who further allocate MAC addresses to specific devices, thus assuring that no two devices are associated with the same MAC address. For example, a MAC address purchased by a manufacturer of networking equipment may be stored in persistent storage on a network interface card (NIC), e.g., an electrically erasable programmable read-only memory (EEPROM) etc. However, by configuring a network interface and/or a communication device, a user may cause a communication device to use a MAC address of choice disregarding the allocation of the IEEE or any other rules or conventions.

As referred to herein, an allocated or unique MAC address may be distinguished from a randomly or otherwise selected or generated MAC address. More specifically, an allocated or unique MAC address may be a unique MAC address obtained via the IEEE and used, by a wireless communication device, during normal operation, e.g., when connected to an AP. A randomly or otherwise selected or generated MAC address may be one used during selected time periods, stages or phases, e.g., when transmitting probe request frames as defined by the IEEE 802.11 standard.

In some embodiments of the invention, an allocated or unique MAC address associated with a wireless communication device may not be revealed or used during an initial or other communication phase or it may not be used when performing specific operations. For example, a MAC address may be randomly or pseudo randomly selected from a pool of MAC addresses to be used when searching for an access point in a wireless network, e.g., when probe requests frames are transmitted, or a MAC address may be randomly or pseudo randomly generated when joining or setting up a wireless network. It will be understood that any algorithm, criteria or rules may be used in order to select a MAC address from a set or pool of MAC addresses where such selected MAC address is to be used when searching for an access point in a wireless network, e.g., included in probe requests frames. Likewise, any algorithm, criteria or rules may be used in order to generate a MAC address used in probe requests frames or other transmissions to a broadcast address.

The description herein generally relates to wireless communication devices that support at least the two lowest network layers of the 802.11 standards (as defined by the Open Systems Interconnection model (OSI) of the International Organization for Standardization (ISO)). These two layers are the physical layer (PHY) and the data layer, in particular, the medium access control (MAC) part of the data layer. However, it will be understood that with suitable modifications, embodiments of the invention may be likewise applicable to other network architectures, designs, protocols or implementations.

The IEEE 802.11 family or suite of standards will be generally referred to herein as the 802.11 standard. For the sake of simplicity and clarity, terms such as access point (AP), station (STA), authentication and association may be best construed or understood as defined by the 802.11 standards. However, it will be evident that embodiments of the invention are not limited to devices compliant with the 802.11 standards and may, possibly under suitable modifications, be applicable to other wireless communication devices, systems, protocols and/or networks.

A wireless network may be implemented by one or more access points (AP) with which wireless communication devices such as laptops or other wireless communication devices may communicate. In a typical scenario, an AP may provide a wireless communication device with a connection to the Internet and/or other networks or other wireless communication devices. As known in the art, in order to join a wireless network, a wireless communication device may search for an AP by transmitting one or more probe request frames as defined by the IEEE 802.11 standard. An AP may respond to a received probe request by transmitting a probe response frame as defined by the IEEE 802.11 standard. Following a reception of a probe response frame, a session between the wireless communication device and the AP may be established. However, since while searching for an AP a wireless communication device may not possess a specific address of a specific AP, probe request frames may typically transmitted to a broadcast address as described herein and thus may be easily received by any wireless communication device in range.

According to embodiments of the invention, a randomly or pseudo randomly selected or generated MAC address may be used by a wireless communication device during a first period of time, e.g., during a phase of searching for a wireless access point (AP) and an allocated MAC address may be used during a second time period, e.g., when and/or after actually connecting to an AP. Accordingly, a MAC address allocated to a wireless communication device as described herein may not be openly transmitted, broadcasted or sent over a wireless network until after an AP or another wireless communication device, with which the wireless communication device whishes to communicate, is located.

According to embodiments of the invention, a wireless communication device may send to a broadcast address one or more probe request frames using a different respective one or more source MAC addresses, receive at least one probe response frame from a second or remote wireless communication device and, using a predefined MAC address, which is different from the one or more source MAC addresses used in the one or more probe request frames, establish a link, a communication channel, or otherwise interact with the second wireless communication device. Embodiments of the invention may be particularly applicable to a wireless network architectures as defined by the Institute of Electrical and Electronics Engineers (IEEE) 802.11 standards family of which current version of the standard is IEEE 802.11-2007. However, it will be understood that embodiments of the invention may be applicable to any suitable wireless network or architecture, in particular, wireless networks in which a first wireless computing device generally establishes a link with a second wireless computing device as described herein.

Generally, an access point may be a device that defines a local wireless network and/or provides wireless communication devices with access to a network. For example, in addition to being present on, or capable of communicating over, a wireless network, an access point may be typically be connected to a wired, e.g., local area network (LAN) or other network, and may enable wireless communication devices to access such other networks. For example, an access point connected to a LAN and further communicating with nearby wireless communication devices may enable such wireless communication devices to access the internet. In addition and in accordance with the 802.11 standard, the description herein may refer to any wireless communication device other than an AP as a station or STA as referred to in the 802.11 standard. Generally, in order to join a wireless network, a STA connects to an AP. Although the description herein may mostly relate to a STA searching for an AP in order to join a wireless network, it will be understood that embodiments of the invention may be equally applicable to other scenarios or networks. For example, embodiments of the invention may be applicable to two or more wireless communication devices that may establish an ad-hoc network. However, for the sake of simplicity and clarity, the description herein will mainly refer to the scenario in which in order to join a wireless network, a STA is required to establish a link, a communication channel or session with an AP. Accordingly, the wireless communication devices mainly referred to herein are an access point (AP) and a client device or station (STA) that may be, for example, a laptop, a PDA or any other user wireless communication device.

Generally, a wireless computing device may scan, connect to, or join a wireless network by performing an active scans. According to an active scan, a STA may send frames known as probe request frames, which are used to search for, probe, or otherwise discover APs. A probe request may be sent to a specific MAC address (to check for a presence of a specific AP), or to a broadcast MAC address (to query all APs in the area). A broadcast address in networking may be similar to shouting in a corridor rather than entering a room and talking to a specific person. Otherwise put, when a message or frame is sent to the broadcast address, any device in suitable range may receive the message, examine its content and possibly act in response. Regardless of the destination MAC address, the probe request may further contain a wildcard service set identifier (SSID) in order to elicit a reply from any AP, or a specific SSID in order to find only APs associated with a certain network (which is associated with the specific SSID). Embodiments of the invention may be applicable to any type of probe requests, e.g., probe requests having a specific SSID, a wildcard SSID and/or sent to a specific MAC address or to a broadcast address.

Upon receiving a probe request frame from a source STA, an AP may reply to the source STA with a probe response frame. In response to a probe response frame, the STA may commence the negotiation required in order to enable the STA to join the wireless network maintained by the AP, or otherwise communicate with the AP. For example, according to the 802.11 standards, the STA may request to be authenticated by the AP, associated with the AP, etc. Accordingly, while searching for a wireless network or searching for an AP, and even while connected to an AP, a wireless communication device may continuously or periodically send to a broadcast address a probe request frames. For example, upon entering an airport terminal, a restaurant, or any public location where wireless networking is enabled or supported, a user's laptop may establish a connection with an AP by transmitting probe request frames to a broadcast address, having such probe request frames answered by probe response frame from an AP, and further negotiating to join the wireless network. Such negotiation may comprise authentication of the STA by the AP, association of the STA with the AP, and/or exchanging encryption keys in order to facilitate secured communication, etc.

However and as discussed herein, frames transmitted to a broadcast address or otherwise sent by a wireless communication device in search of an AP may be captured by a hostile device or user. Further aggravating the problem is the fact that devices, even when or while connected to an AP typically perform a scan (namely, send a probe request) every few minutes, although this is not required by the standard. For example, in order to determine whether roaming is possible a device may transmitted to a broadcast address a probe request periodically. Since these probe requests are not triggered by a user, a user of a wireless communication device can not stop his or her device from such broadcasting the device's MAC address thus enabling any device equipped to receive probe requests to obtain the MAC address. Otherwise put, a typical wireless communication device continuously broadcasts sensitive information (e.g., its MAC address) thus enabling a security breach. As described herein, such security breach may be prevented by embodiments of the invention.

The active scan, and in particular, transmission to a broadcast address of probe request frames, may jeopardize data or information a security and/or privacy. As described herein, a device other than the AP, suitably equipped or configured, e.g., equipped with a suitable antenna, may receive the broadcasted probe request frames. Accordingly, information contained in a probe request frame may be obtained by any device suitably equipped or configured to listen to the broadcast address. For example, a MAC address of the wireless communication device that transmits probe request frames to a broadcast address may be received and/or recorded by any device that receives these frames.

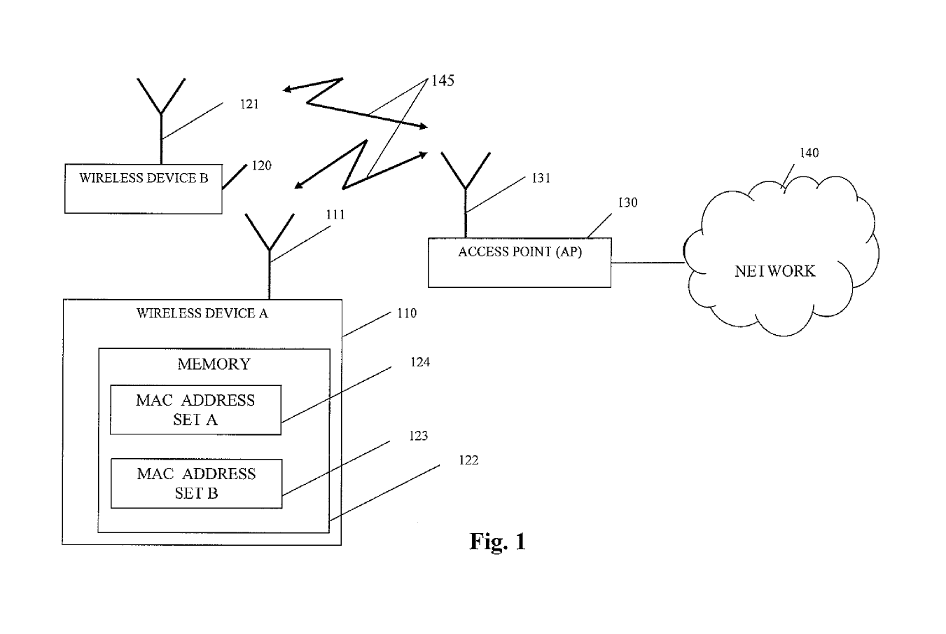

Reference is now made to FIG. 1 showing an exemplary wireless network system according to embodiments of the invention. As shown, the wireless network may comprise wireless communication device A 110 equipped with antenna 111, wireless communication device B 120 equipped with antenna 121, access point 130 equipped with antenna 131, and network 140. As shown, wireless communication devices 110 and 120 may communicate with access point 130 over channel 145. Network 140 may be, may comprise or may be part of a private or public internet protocol (IP) network, or the internet, a combination thereof or any other applicable network as known in the art.

Wireless communication devices 110 and 120 may generally be an apparatus comprising a receiver, a transmitter, a controller and a memory. The memory may be configured to store at least one set of medium access control (MAC) addresses as described herein. The transmitter may be configured to transmit at least one probe request frame and, possibly upon receiving (by the receiver) a probe response frame, the transmitter may transmit an authentication frame. The receiver may be configured to receive a probe response frame as well as any other frames, messages, packets or any other communication. The controller may be configured to select a first MAC address for a probe request frame and a second MAC address for an authentication frame, wherein the first MAC address is different from the second MAC address.

As shown, wireless communication device 110 may include a memory 122 to store MAC address sets 123 and 124. In some embodiments, a controller (not shown) included in wireless communication device 110 may randomly, pseudo randomly or otherwise select a MAC address from sets 123 and/or 124. In some embodiments, a predefined algorithm may be used to select a MAC address from sets 123 and/or 124. For example, a MAC address used for transmitting probe request frames may be randomly selected from set 123 and a MAC address used for authenticating wireless communication device 110 and/or for establishing a link (e.g., with an access point) may be selected from set 124. In yet other embodiments, more or less MAC address sets may be used. For example, a MAC address used for transmitting probe request frames may be partially or wholly generated, thus a set of MAC address for transmitting probe request frames may not be required.

It will be recognized that embodiments of the invention are not limited by the nature of network 140. It will further be understood that FIG. 1 shows a highly simplified wireless network to be used for the purpose of illustration of embodiments of the invention which may be applicable to far more complicated wireless networks. For example, a large number of wireless communication devices similar to devices 110 and 120 may be present in a typical embodiment. Likewise, any applicable number of access points similar to access point 130 may be comprised in real embodiments of the invention, and such access points may be connected to any suitable number of networks 140. Using their respective antennas 111 and 121, wireless communication devices A and B may communicate with one another and/or with access point 130 via its antenna 131. As described herein, wireless communication devices A and B may search for an access point by transmitting probe request frames to a broadcast address, such frames may be received by access point 130. Access point 130 may reply to such probe request frames with probe response frames following which other protocol messages may be exchanged, e.g., as defined by the 802.11 standards and described herein.

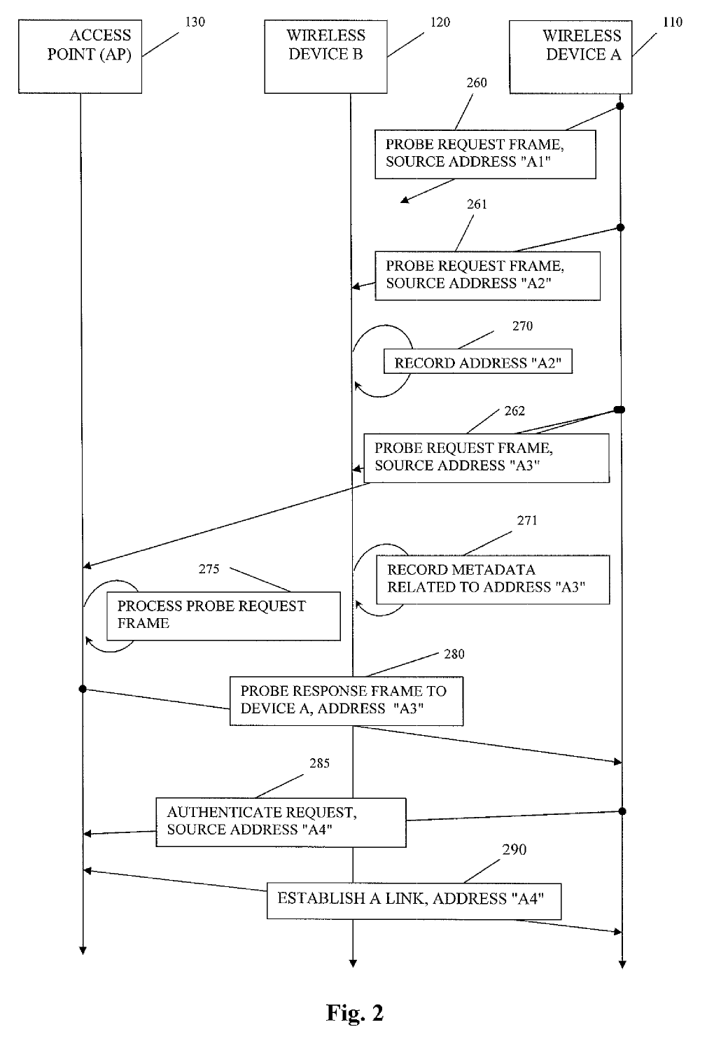

Reference is now made to FIG. 2, showing an exemplary time event flow chart according to embodiments of the invention. As shown by blocks 260, 261 and 262, in a method or flow according to embodiments of the invention, wireless communication device A may transmit probe request frames to a broadcast address in search of an access point. To send such probe request frames, wireless communication device A may use MAC addresses other than its allocated MAC address. As further shown by blocks 260, 261 and 262, wireless communication device A may use a number of different fake or “dummy” MAC addresses until a connection is made with the AP. As shown by block 260, in the first probe request frame (transmitted to a broadcast address), wireless communication device A may use MAC addresses “A1”. According to embodiments of the invention, wireless communication device A may dynamically and/or temporarily associate itself with address “A1” in the sense that should a response or other message to address “A1” be transmitted (e.g., by access point 130), wireless communication device A will be able to receive such response or message. As before, in an exemplary case, the first probe request frame may not reach any device, accordingly and as shown by 261, wireless communication device A may transmit a second probe request frame to a broadcast address using a second source MAC address “A2” and may now dynamically and/or temporarily associate itself with address “A2” so that it will be capable of receiving a response or message destined to address “A2”.

As shown, the second probe request frame (block 261) may not be received by access point 130 (which may, as before, be too far from wireless communication device A) but may be received by wireless communication device B. As shown by block 270, having received a probe request frame from wireless communication device A, wireless communication device B may record the address in the probe request frame, which is address “A2”. Since wireless communication device A has not received an expected probe response frame, it transmits a third probe request frame to a broadcast address as shown by block 262, this time, using a third source address “A3” and dynamically associates itself with, or otherwise listens to communications destined to, address “A3”. As shown, this last frame may also be received by both wireless communication device B and access point 130. As discussed herein and shown by block 271, wireless communication device B may record metadata information related to a received probe response frame. However, and as shown, metadata recorded may be associated to address “A3” and accordingly, unassociated with address “A2” previously recorded by wireless communication device B. Accordingly, since wireless communication device A changes its nominal source address, recording meaningful or valuable metadata by wireless communication device B may be prevented. As shown by block 275, and described herein, access point 130 may process the received probe request frame 262 and respond as shown by block 280 with a probe response frame using address “A3” as the destination, since this was the source address in the received probe response frame 262.

As shown by 285, wireless communication device A may respond to the probe response frame 280 with a request to be authenticated or otherwise, e.g., in accordance with a protocol used for joining a wireless network or being provided services by an access point. However, and as shown by 285, when communicating directly with access point 130, wireless communication device may now use a fourth source address “A4” which may be a real MAC address, e.g., one uniquely assigned to wireless communication device A. Accordingly, address “A4” may be referred to herein as a protected or secured address since it is protected from eavesdropping or otherwise being recorded as described herein. Likewise, and for similar reasons, a device such as wireless communication device A may be referred to herein as a protected device. In some embodiments, a protected or real address such as address “A4” may itself be selected from a provided or predefined pool of addresses. For example, wireless communication device A may be provided with four different address, each of which may be authentic, registered, and/or allocated to a specific manufacturer and uniquely used by wireless communication device A, and any one of these addresses may be randomly or otherwise selected to be used as address “A4” as shown by 285. As shown by 290, wireless communication device A may establish a link with AP 130 using address “A4”. A link established as shown by 290 may be any link that may enable wireless device 110 to communicate with AP 130 using any protocol and/or protocol layers.

Although only a number of exemplary transactions are described herein with respect to FIG. 2, it will be understood that any number of transactions in which a device such as wireless communication device A uses dynamic, alternated source addresses are possible. In some embodiments, a pool of addresses may be provided to wireless communication device A and wireless communication device A may randomly or otherwise select addresses (such as addresses “A1”, “A2” and “A3”) from such pool. In other embodiments wireless communication device A may randomly or otherwise generate such addresses, e.g., based on some rules or parameters. For example, a first portion (e.g., three octets) of a MAC address may be predefined or fixed and wireless communication device A may randomly or based on some rule generate or select a second portion the address. For example, wireless communication device A may be provided with the address “3A-DF-55-XX-XX-XX” and may replace the “XX-XX-XX” section or portion by randomly generated combinations, by combinations selected from a separately provided pool or set or by any other means. It will be understood that the any method, process or means for obtaining, selecting, generating or otherwise providing addresses such as “A1”, “A2” and “A3” to be used for communicating messages without disclosing a protected address may be used without departing from the scope of embodiments of the invention.

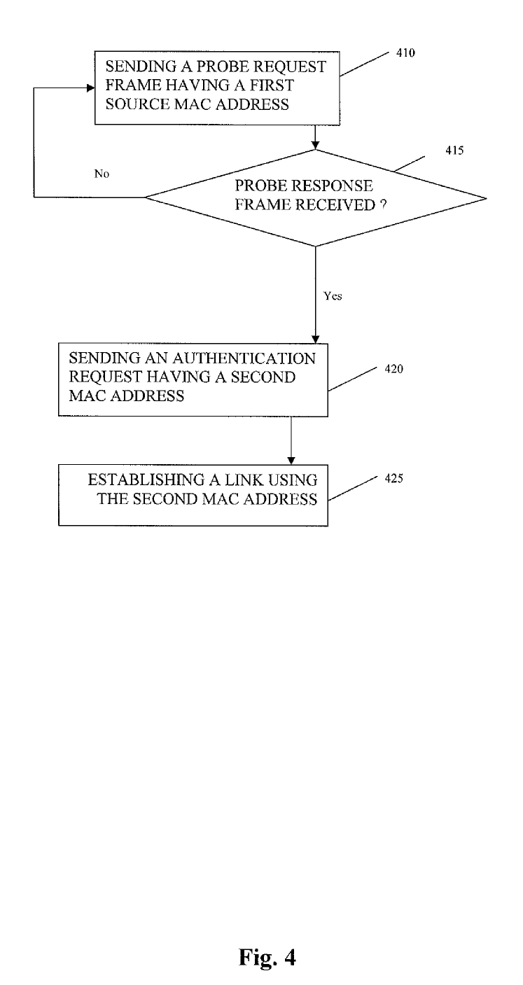

Reference is made to FIG. 4, which is an exemplary flowchart describing a method according to some embodiments of the present invention. As shown by block 410, a method or flow may include sending a probe request frame having a first source MAC address. For example, a MAC address may be selected (according to any algorithm or method) from a set of MAC addresses, e.g., MAC address set 124 shown in FIG. 1. In other embodiments, a MAC address used as shown in block 410 may be randomly, pseudo-randomly, or otherwise generated. As shown by block 415, a flow may include determining a probe response frame was received. For example, following transmission of one or more probe request frames (that may include respective one or more MAC addresses) as shown by block 410 a probe response may be received, e.g., from an access point. As shown, if a probe response frame is not received (e.g., within a predefined period after a probe request frame was transmitted) then sending a probe request frame as shown by block 410 may be repeated.

As shown by block 420, a method or flow may include sending an authentication request having a second MAC address. For example, upon receiving a probe response frame, a wireless device may initiate an authentication (e.g., with or by an access point). As shown by block 425, a method or flow may include establishing a link using the second MAC address. For example, a wireless device may use the second MAC address (which may be an allocated and unique address) in order to establish a link with an access point.

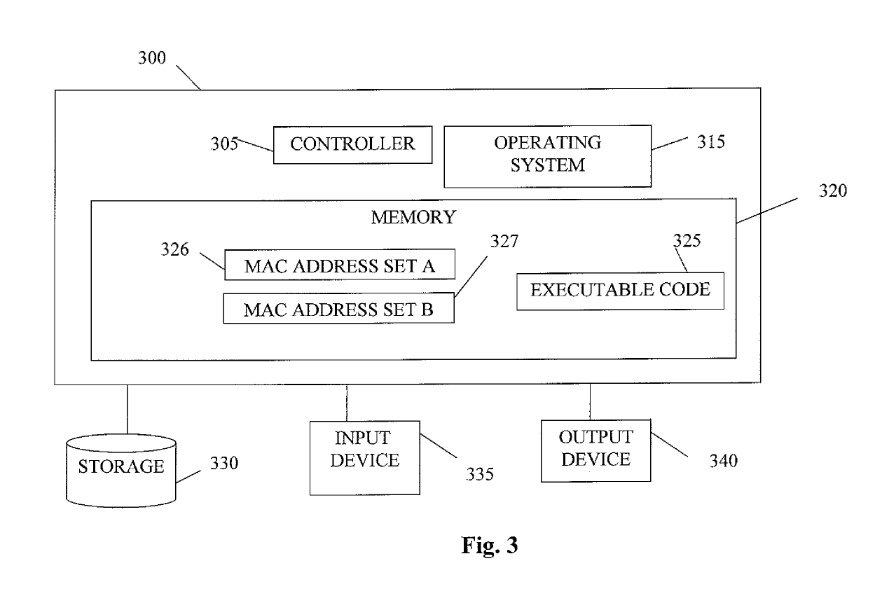

reference is made to FIG. 3, showing high level block diagram of an exemplary computing device according to embodiments of the present invention. Computing device 300 may include a controller 305 that may be, for example, a central processing unit processor (CPU), a chip or any suitable computing or computational device, an operating system 315, a memory 320, a storage 330, an input device 335 and an output device 340.

Operating system 315 may be or may include any code segment designed and/or configured to perform tasks involving coordination, scheduling, arbitration, supervising, controlling or otherwise managing operation of computing device 300, for example, scheduling execution of programs. Operating system 315 may be a commercial operating system. Memory 320 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 320 may be or may include a plurality of, possibly different memory units. As shown, an executable code 325 and MAC address sets 326 and 327 may be loaded into memory 320.

Executable code 325 may be any executable code, e.g., an application, a program, a process, task or script. For example, executable code 325 may be configured to randomly or otherwise generate MAC addressees as described herein, generate, send and/or receive probe request frames and/or probe response frames, cause an antenna to transmit data etc. Executable code 325 may be configured to randomly or otherwise select MAC addressees from MAC address sets 326 and/or 327 as described herein. For example, MAC address set 326 may be a set of allocated unique addresses purchased by a manufacturer and used for authenticating a wireless device and/or establishing a link and MAC address set 327 may be a set of MAC addresses used for transmitting probe request frames. Executable code 325 may be executed by controller 305 possibly under control of operating system 315. Storage 330 may be or may include, for example, a hard disk drive, a floppy disk drive, a Compact Disk (CD) drive, a CD-Recordable (CD-R) drive, a universal serial bus (USB) device or other suitable removable and/or fixed storage unit.

Input devices 335 may be or may include an antenna, a mouse, a keyboard, a touch screen or pad or any suitable input device. It will be recognized that any suitable number of input devices may be operatively connected to computing device 300 as shown by block 335. Output devices 340 may include one or more antennas, displays, speakers and/or any other suitable output devices. It will be recognized that any suitable number of output devices may be operatively connected to computing device 300 as shown by block 340. Any applicable input/output (I/O) devices may be connected to computing device 300 as shown by blocks 335 and 340. For example, a wireless network interface card (NIC), a printer or facsimile machine, a universal serial bus (USB) device or external hard drive may be included in input devices 335 and/or output devices 340. According to embodiments of the invention, wireless computing devices 110, 120 and access point 130 may comprise all or some of the components comprised in computing device 300 as shown and described herein.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein. For example, a storage medium such as memory 320, computer-executable instructions such as executable code 325 and a controller such as controller 305. For example, such article may be a wireless computing device or a computer capable of performing wireless communication which may comprise such processor or controller and storage medium where the storage medium stores instructions that may cause the article to send one or more probe request frames using a respective one or more source MAC addresses, receive at least one probe response frame from a remote wireless communication device (e.g., from an AP) and using a predefined source MAC address (e.g., an allocated MAC address or a MAC address selected from a set of allocated or unique MAC addresses), establish a link with the second wireless communication device. Some embodiments may be provided in a computer program product that may include a machine-readable medium, stored thereon instructions, which may be used to program a computer, or other programmable devices, to perform methods as disclosed above.

While certain features of embodiments of the invention have been illustrated and described herein, many modifications, substitutions, changes, and equivalents may occur to those skilled in the art. It is, therefore, to be understood that the appended claims are intended to cover all such modifications and changes as fall within the true spirit of embodiments of the invention.

What is claimed is:

1. A method of securing information of a wireless communication device, the method comprising:
sending a probe request frame having a first source medium access control (MAC) address;
receiving at least one probe response frame;
sending an authentication request having a second MAC address; and
establishing a link using the second MAC address, wherein said first MAC address is different from said second MAC address.

2. The method of claim 1, comprising: randomly generating one or more source MAC addresses.

3. The method of claim 1, comprising: randomly selecting one or more source MAC addresses from a predefined set of MAC addresses.

4. The method of claim 1, comprising establishing the link between a wireless communication device and an access point.

5. An article comprising a computer-readable storage medium, having stored thereon instructions, that when executed on a computer, cause the computer to:
send a probe request frame having a first source medium access control (MAC) address;
receive at least one probe response frame;
send an authentication request having a second MAC address; and
establish a link using the second MAC address, wherein said first MAC address is different from said second MAC address.

6. The article of claim 5, wherein the instructions when executed further result in randomly generating one or more source MAC addresses.

7. The article of claim 5, wherein the instructions when executed further result in randomly selecting one or more source MAC addresses from a predefined set of MAC addresses.

8. The article of claim 5, wherein the instructions when executed further result in establishing the link between a wireless communication device and an access point.

9. A wireless communication system comprising an antenna, a controller and a memory to store at least one set of medium access control (MAC) addresses, the wireless communication system to:
send a probe request frame having a first source medium access control (MAC) address;
receive at least one probe response frame;
send an authentication request having a second MAC address; and
establish a link using the second MAC address, wherein said first MAC address is different from said second MAC address.

10. The wireless communication system of claim 9, wherein the controller is configured to randomly generate one or more source MAC addresses.

11. The wireless communication system of claim 9, wherein the controller is configured to randomly select one or more source MAC addresses from a predefined set of MAC addresses.

12. The wireless communication system of claim 9, wherein the controller is configured to establish the link with an access point.

13. An apparatus comprising a receiver, a transmitter, a controller and a memory, wherein the memory is configured to store at least one set of medium access control (MAC) addresses, the transmitter is configured to transmit a probe request frame and an authentication frame, the receiver is configured to receive a probe response frame and the controller is configured to select a first MAC address for the probe request frame and a second MAC address for the authentication frame and wherein the first MAC address is different from the second MAC address.

14. The apparatus of claim 13, wherein the controller is configured to randomly generate one or more source MAC addresses.

15. The apparatus of claim 13, wherein the controller is configured to randomly select one or more source MAC addresses from a predefined set of MAC addresses.

16. The apparatus of claim 13, wherein the controller is configured to establish the link with an access point.
